(19) United States
(12) Patent Application Publication
(10) Pub. No.: US 2026/0323693 A1
(43) Pub. Date: Oct. 15, 2026

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Lin LIANG, Beijing (CN); Gang WANG, Beijing (CN)

(73) Assignee: NEC Corporation, Tokyo (JP)

(21) Appl. No.: 19/101,097

(22) PCT Filed: Aug. 8, 2022
(86) PCT No.: PCT/CN2022/110932

§ 371 Date: Feb. 4, 2025

(51) Int. Cl. H04W 74/0816; H04W 74/0808

(52) U.S. Cl. CPC H04W 74/0816; H04W 74/0825

(57) ABSTRACT

Embodiments of the present disclosure relate to methods, devices and computer readable media of communication. A terminal device receives a first configuration indicating a set of first occasions and a second configuration indicating a set of second occasions. The set of first occasions is associated with a first operation for the first network device or a second network device, and the set of second occasions is associated with a second operation for the second network device in a MUSIM gap. If a first occasion in the set of first occasions is overlapped with a second occasion in the set of second occasions, the terminal device performs one of the first operation and the second operation at least based on periodicity of the MUSIM gap. In this way, MUSIM gap collision may be handled.

### TECHNICAL FIELD

Embodiments of the present disclosure generally relate to the field of telecommunication, and in particular, to methods, devices and computer storage media of communication for a multi-universal subscriber identity module (MUSIM).

### BACKGROUND

As known, MUSIM gaps are defined for a terminal device to switch from a network A of USIM A to a network B of USIM B for operation in the network B. Currently, it is proposed to define radio resource management (RRM) requirements for MUSIM gaps, in particular, to identify and specify solutions for handing collisions between a MUSIM gap and other occasions. However, the solutions for handing the collisions are still incomplete and need to be further developed.

### SUMMARY

In general, embodiments of the present disclosure provide methods, devices and computer storage media of communication for MUSIM gap collision handling.

In a first aspect, there is provided a method of communication. The method comprises: receiving, at a terminal device and from a first network device, a first configuration indicating a set of first occasions, the set of first occasions being associated with a first operation for the first network device or a second network device; receiving, from the first network device, a second configuration indicating a set of second occasions, the set of second occasions being associated with a second operation for the second network device in a MUSIM gap; and in accordance with a determination that a first occasion in the set of first occasions is overlapped with a second occasion in the set of second occasions, performing one of the first operation and the second operation at least based on periodicity of the MUSIM gap.

In a second aspect, there is provided a method of communication. The method comprises: transmitting, at a first network device and to a terminal device, at least one of the following: a third configuration indicating a time domain multiplexing (TDM) pattern, the TDM pattern indicating whether a first operation for the first network device or a second network device or a second operation for the second network device is performed; a fourth configuration indicating at least one of a first priority of a first occasion for the first operation or a second priority of a second occasion for the second operation; a fifth configuration indicating at least one of a third priority of the first operation or a fourth priority of the second operation; an indication of applying a first relaxed minimum requirement for the first operation; an indication of applying a second relaxed minimum requirement for the second operation; or a configuration of a first factor for the first operation.

In a third aspect, there is provided a device of communication. The device comprises a processor configured to cause the device to perform the method according to any of the first to second aspects of the present disclosure.

In a fourth aspect, there is provided a computer readable medium having instructions stored thereon. The instructions, when executed on at least one processor, cause the at least one processor to perform the method according to any of the first to second aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication scenario in which some embodiments of the present disclosure can be implemented;

FIG. 2A illustrates an example scenario of MUSIM gap collision in which some embodiments of the present disclosure can be implemented;

FIG. 2B illustrates another example scenario of MUSIM gap collision in which some embodiments of the present disclosure can be implemented;

FIG. 2C illustrates still another example scenario of MUSIM gap collision in which some embodiments of the present disclosure can be implemented;

FIG. 2D illustrates yet another example scenario of MUSIM gap collision in which some embodiments of the present disclosure can be implemented;

FIG. 3 illustrates a schematic diagram illustrating a process of communication for MUSIM gap collision handling according to embodiments of the present disclosure;

FIG. 4 illustrates an example method of communication implemented at a terminal device in accordance with some embodiments of the present disclosure;

FIG. 5 illustrates an example method of communication implemented at a first network device in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “subscriber identity module (SIM)” refers to a universal subscriber identity module used in a terminal device. Examples of the SIM include, but not limited to, SIM card, USIM card, ISIM card, MUSIM card, or the like. The term “SIM” can be used interchangeably with a USIM or ISIM or MUSIM.

It is assumed that a terminal device having USIM A and USIM B has established a connection in a network A of USIM A and stays in an idle or inactive state in a network B of USIM B. In this case, if the terminal device needs to handle an incoming service from the network B, the terminal device may perform a switch to the network B.

Generally, the network A may configure at most 3 gap patterns for MUSIM purpose: two periodic gaps and a single aperiodic gap. However, corresponding RRM requirements are not specified. Without corresponding RRM requirements, implementing a MUSIM feature in practical deployment may not guarantee minimized impact on the network A and there could be interoperability issues. In some scenarios, there may be a collision between an occasion for a MUSIM gap and another occasion such as for a measurement gap, a synchronization signal and physical broadcast channel block (SSB)-based RRM measurement timing configuration (SMTC), a SSB, a channel state information-reference signal (CSI-RS), or another MUSIM gap.

Embodiments of the present disclosure provide a solution for MUSIM gap collision handing. In the solution, a terminal device receives, from a first network device (e.g., the network A), a first configuration indicating a set of first occasions and a second configuration indicating a set of second occasions. The set of first occasions is associated with a first operation for the first network device or a second network device (e.g., the network B), and the set of second occasions is associated with a second operation for the second network device in a MUSIM gap. If a first occasion in the set of first occasions is overlapped with a second occasion in the set of second occasions, the terminal device performs one of the first operation and the second operation at least based on periodicity of the MUSIM gap. In this way, RRM requirements for MUSIM are defined and MUSIM gap collision is solved. Accordingly, network performance, particular for the network A, is guaranteed.

In the context of the present disclosure, the term “MUSIM gap collisions” may at least refer to any of the following:
a collision between a MUSIM gap and a measurement gap for network A;
a collision between a MUSIM gap and a SMTC occasion for network A (for intra-frequency measurement or radio link monitoring or beam failure monitoring);
a collision between a MUSIM gap and a SSB occasion for network A;
a collision between a MUSIM gap and a CSI-RS occasion for network A;
a collision between a MUSIM gap and a PRS occasion for network A;
a collision between a MUSIM gap and another MUSIM gap.

In the context of the present disclosure, a MUSIM gap occasion and SMTC occasion/CSI-RS occasion/PRS measurement occasion/measurement gap/MUSIM gap #2 occasion are considered colliding if at least one of the following conditions is met:
two occasions are fully or partially overlapping in time domain, or
a distance between two occasions is equal to or smaller than a threshold distance, e.g., the threshold distance may be equal to or larger than 4 ms or any other suitable values. The distance between two occasions is defined as time difference between an ending point of one occasion and a starting point of another occasion later in time than the one occasion.

Principles and implementations of the present disclosure will be described in detail below with reference to the figures.

### Example of Communication Network

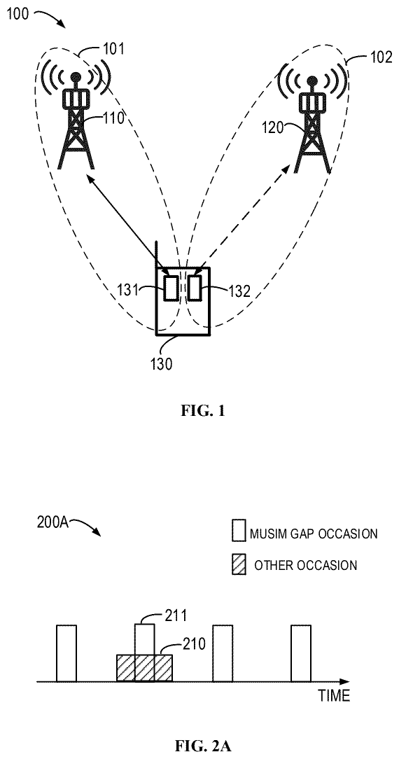

FIG. 1 illustrates a schematic diagram of an example communication scenario 100 in which embodiments of the present disclosure can be implemented. As shown in FIG. 1, the communication scenario 100 may involve a first communication network 101 (e.g., the network A) comprising a first network device 110 and a second communication network 102 (e.g., the network B) comprising a second network device 120. It is to be understood that the first network device 110 is merely an example of network devices in the first communication network 101, and in fact, the first communication network 101 may further comprise more network devices. Similarly, the second network device 120 is merely an example of network devices in the second communication network 102, and in fact, the second communication network 102 may further comprise more network devices.

The communication scenario 100 may also involve a terminal device 130 carrying a first USIM 131 and a second USIM 132. The first USIM 131 communicates with external environment via the first communication network 101, and the second USIM 132 communicates with external environment via the second communication network 102. That is, the first USIM 131 is served by network devices in the first communication network 101, and the first USIM 132 is served by network devices in the second communication network 102.

The first and second USIMs 131 and 132 may conform same or different RATs which are existing now or to be developed in the future. That is, the first and second communication networks 101 and 102 may conform same or different RATs. It should be noted that the number of the USIMs carried by the terminal device 130 is not limited to two, and more than two USIMs also can be applied. Accordingly, it is also to be noted that the communication scenario 100 may involve more communication networks serving the USIMs. For convenience, the following description is given by taking two USIMs and two corresponding communication networks as an example.

It is to be understood that the first network device 110 may also support the second communication network 102, and the second network device 120 may also support the first communication network 101. Thus, the first network device 110 may serve at least one of the first and second USIMs 131 and 132. The second network device 120 may also serve at least one of the first and second USIMs 131 and 132. For convenience, unless otherwise stated, the following description is made under the assumption that the first network device 110 serves the first USIM 131 and the second network device 120 serves the second USIM 132. However, it should be noted that, it is merely an example for illustration, and does not make limitation for the present disclosure. For example, the first and second USIMs 131 and 132 may be served by the same network device such as the first network device 110 or the second network device 120.

The first network device 110 may communicate with the terminal device 130 via a channel such as a wireless communication channel. Similarly, the second network device 120 may also communicate with the terminal device 130 via a channel such as a wireless communication channel. In some embodiments where the first network device 110 supports the first communication network 101 and the second network device 120 supports the second communication network 102, the first USIM 131 may communicate with the first network device 110, and the second USIM 132 may communicate with the second network device 120. In some embodiments where the first network device 110 supports the second communication network 102 and the second network device 120 supports the first communication network 101, the first USIM 131 may communicate with the second network device 120, and the second USIM 132 may communicate with the first network device 110. In some embodiments where the first network device 110 supports both the first and second communication network 101 and 102, both the first USIM 131 and the second USIM 132 may communicate with the first network device 110. In some embodiments where the second network device 120 supports both the first and second communication network 101 and 102, both the first USIM 131 and the second USIM 132 may communicate with the second network device 120.

It is to be understood that the number of devices in FIG. 1 is given for the purpose of illustration without suggesting any limitations to the present disclosure. The communication scenario 100 may include any suitable number of network devices and/or terminal devices adapted for implementing implementations of the present disclosure.

The communications in the communication scenario 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some scenarios, the terminal device 130 is under a connected state in the first communication network 101, and under an idle or inactive state in the second communication network 102. The first network device 110 may configure MUSIM gaps for the terminal device 130 to perform short time service at the second communication network 102 while remaining the connected state in the first communication network 101. The device first network 110 also may configure measurement gap/SMTC/SSB/CSI-RS/PRS for measurement of the communication network 101.

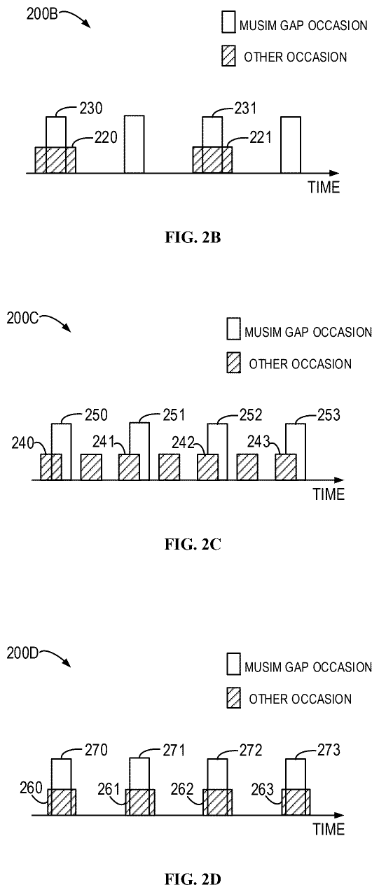

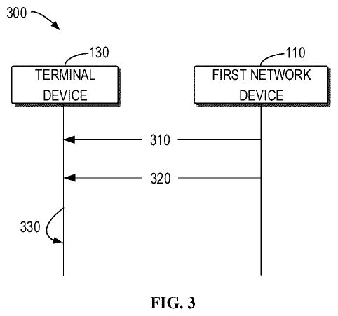

In some scenarios, an occasion for a MUSIM gap may collide with another occasion for measurement gap, SMTC, SSB, CSI-RS, PRS or another MUSIM gap. FIG. 2A illustrates an example scenario 200A of MUSIM gap collision in which some embodiments of the present disclosure can be implemented. In this example, the collision is caused by an aperiodic MUSIM gap. As shown in FIG. 2A, an occasion 210 for an aperiodic MUSIM gap is overlapped with another occasion 211 for measurement gap, SMTC, SSB, CSI-RS, PRS or another MUSIM gap. It is to be understood that FIG. 2A is merely an example, the occasion 210 may also be partially overlapped with the occasion 211, or a distance between the occasion 210 and the occasion 211 is equal to or smaller than a threshold distance. In these scenarios, a collision will also be caused.

FIG. 2B illustrates an example scenario 200B of MUSIM gap collision in which some embodiments of the present disclosure can be implemented. In this example, the collision is caused by partial overlapping under different periodicities of an occasion for a periodic MUSIM gap and another occasion for measurement gap, SMTC, SSB, CSI-RS, PRS or another MUSIM gap. Periodicity of an occasion for periodic MUSIM gap is larger than periodicity of another occasion for measurement gap, SMTC, SSB, CSI-RS, PRS or another MUSIM gap. As shown in FIG. 2B, occasions 220 and 221 for an periodic MUSIM gap are overlapped with occasions 230 and 231 for measurement gap, SMTC, SSB, CSI-RS, PRS or another MUSIM gap. It is to be understood that FIG. 2B is merely an example, the occasions 220 and 221 may also be partially overlapped with the occasions 230 and 231, or a distance between the occasion 220 and the occasion 230 and a distance between the occasion 221 and the occasion 231 are equal to or smaller than a threshold distance. In these scenarios, a collision will also be caused.

FIG. 2C illustrates an example scenario 200C of MUSIM gap collision in which some embodiments of the present disclosure can be implemented. In this example, the collision is caused by partial overlapping under different periodicities of an occasion for a periodic MUSIM gap and another occasion for measurement gap, SMTC, SSB, CSI-RS, PRS or another MUSIM gap. Periodicity of an occasion for periodic MUSIM gap is smaller than periodicity of another occasion for measurement gap, SMTC, SSB, CSI-RS, PRS or another MUSIM gap. As shown in FIG. 2C, occasions 240, 241, 242, 243 for an periodic MUSIM gap are partially overlapped with occasions 250, 251, 252 and 253 for measurement gap, SMTC, SSB, CSI-RS, PRS or another MUSIM gap. It is to be understood that FIG. 2C is merely an example, the occasions 240, 241, 242, 243 may also be fully overlapped with the occasions 250, 251, 252 and 253, or a distance between the occasion 240 and the occasion 250, a distance between the occasion 241 and the occasion 251, a distance between the occasion 242 and the occasion 252 and a distance between the occasion 243 and the occasion 253 are equal to or smaller than a threshold distance. In these scenarios, a collision will also be caused.

FIG. 2D illustrates an example scenario 200D of MUSIM gap collision in which some embodiments of the present disclosure can be implemented. In this example, the collision is caused by overlapping under a same periodicity of an occasion for a periodic MUSIM gap and another occasion for measurement gap, SMTC, SSB, CSI-RS, PRS or another MUSIM gap. As shown in FIG. 2D, occasions 260, 261, 262, 263 for an periodic MUSIM gap are overlapped with occasions 270, 271, 272 and 273 for measurement gap, SMTC, SSB, CSI-RS, PRS or another MUSIM gap. It is to be understood that FIG. 2D is merely an example, the occasions 260, 261, 262, 263 may also be partially overlapped with the occasions 270, 271, 272 and 273, or a distance between the occasion 260 and the occasion 270, a distance between the occasion 261 and the occasion 271, a distance between the occasion 262 and the occasion 272 and a distance between the occasion 263 and the occasion 273 are equal to or smaller than a threshold distance. In these scenarios, a collision will also be caused.

However, in case that an occasion for a MUSIM gap may collide with that for measurement gap/SMTC/SSB/CSI-RS/PRS, the terminal device 130 cannot perform a service for the second communication network 102 and a measurement for the first communication network 101 at the same time. In case of multiple MUSIM gaps configured to the terminal device 130 and collision happens between MUSIM gaps (e.g., an aperiodic MUSIM gap collides with periodic MUSIM gap), the terminal device 130 cannot perform behaviors corresponding to different MUSIM gaps.

In view of this, embodiments of the present disclosure provide a solution of communication for handling MUSIM gap collisions so as to overcome the above and other potential issues. For illustration, more details of the solution will be described with reference to FIG. 3.

### Example Implementation of Musim Gap Collision Handling

FIG. 3 illustrates a schematic diagram illustrating a process 300 of communication for MUSIM gap collision handling according to embodiments of the present disclosure. For the purpose of discussion, the process 300 will be described with reference to FIG. 1. The process 300 may involve the first network device 110, the second network device 120 and the terminal device 130 as illustrated in FIG. 1. It is assumed that the terminal device 130 is in a connected state for the first network device 110 and is in an idle or inactive state for the second network device 120.

As shown in FIG. 3, the first network device 110 transmits 310, to the terminal device 130, a first configuration indicating a set of first occasions. The set of first occasions is associated with a first operation for the first network device 110 or the second network device 120.

In some embodiments, the set of first occasions may be used for a measurement gap. In these embodiments, the first operation may comprise a signal measurement for the first network device 110.

In some embodiments, the set of first occasions may be used for SMTC. In these embodiments, the first operation may comprise radio link failure monitoring, beam failure monitoring, an intra-frequency measurement or inter-frequency measurement for the first network device 110.

In some embodiments, the set of first occasions may be used for CSI-RS. In these embodiments, the first operation may comprise CSI-RS measurement for the first network device 110.

In some embodiments, the set of first occasions may be used for PRS. In these embodiments, the first operation may comprise PRS measurement for the first network device 110.

In some embodiments, the set of first occasions may be used for SSB. In these embodiments, the first operation may comprise a SSB measurement for the first network device 110.

In some embodiments, the set of first occasions may be used for a MUSIM gap. In some embodiments, the first operation may comprise a cell measurement or paging reception for the second network device 120.

Continue to refer to FIG. 3, the first network device 110 also transmits 320, to the terminal device 130, a second configuration indicating a set of second occasions. The set of second occasions is associated with a second operation for the second network device 120 in a MUSIM gap. In some embodiments, the second operation may comprise a cell measurement or paging reception for the second network device 120 in this MUSIM gap.

With reference to FIG. 3, if a first occasion in the set of first occasions is overlapped with a second occasion in the set of second occasions, the terminal device 130 performs 330 one of the first operation and the second operation at least based on periodicity of the MUSIM gap corresponding to the second occasion. For illustration, some example embodiments will be described below in connection with Embodiments 1 to 8.

### Embodiment 1

In this embodiment, the second occasion is an aperiodic MUSIM gap occasion.

In some embodiments, if the second occasion collides with the first occasion (such as a SMTC occasion, a measurement gap occasion, a SSB occasion, a CSI-RS occasion, a PRS occasion, or another MUSIM gap occasion), the terminal device 110 may drop the first occasion. In some embodiments, the terminal device 110 may perform the second operation on the second occasion. That is, the terminal device 110 may switch to the second communication network 102 during the aperiodic gap occasion, and the SMTC occasion, the measurement gap occasion, the SSB occasion, the CSI-RS occasion, the PRS occasion, or the other MUSIM gap occasion may be considered to be dropped.

In this way, a MUSIM service at network B may be performed in case of collision happens.

### Embodiment 2

In this embodiment, the second occasion is a periodic MUSIM gap occasion.

In some embodiments, if the second occasion collides with the first occasion (such as a SMTC occasion, a measurement gap occasion, a SSB occasion, a CSI-RS occasion, or a PRS occasion, or another MUSIM gap occasion), the terminal device 110 may drop the first occasion. In some embodiments, the terminal device 110 may perform the second operation on the second occasion. That is, the terminal device 110 may switch to the second communication network 102 during the aperiodic gap occasion, and the SMTC occasion, the measurement gap occasion, the SSB occasion, the CSI-RS occasion, the PRS occasion, or the other MUSIM gap occasion may be considered to be dropped.

In some alternative embodiments, if the second occasion collides with the first occasion, the terminal device 110 may drop the second occasion. In some embodiments, the terminal device 110 may perform the first operation on the first occasion. That is, the terminal device 110 may drop the MUSIM gap occasion.

In this way, MUSIM gap collision may be solved by always dropping MUSIM gap occasion or the other occasion.

### Embodiment 3

In this embodiment, the second occasion is a periodic MUSIM gap occasion.

In some embodiments, if the second occasion collides with the first occasion (such as a SMTC occasion, a measurement gap occasion, a SSB occasion, a CSI-RS occasion, a PRS occasion, or another MUSIM gap occasion), the terminal device 110 may determine the one of the first operation and the second operation based on a time domain multiplexing (TDM) pattern. The TDM pattern means a pattern of which behavior the terminal device 130 should perform for the collision. That is, based on a TDM pattern, the terminal device 110 may either drop the first occasion and switch to the second communication network 102 to perform the second operation, or drop the second occasion to perform the first operation.

In some embodiments, the TDM pattern may be pre-defined. For example, for one collision, the second operation may be performed on the second occasion while dropping the first occasion. For the next collision, the first operation may be performed on the first occasion while dropping the second occasion. It is to be understood that this is merely an example, and any other pre-defined ways are also feasible.

In some embodiments, the first network device 110 may transmit, to the terminal device 130, a third configuration indicating the TDM pattern. In this way, a TDM pattern may be configured flexibly.

In some embodiments, the terminal device 130 may transmit a suggested TDM pattern to the first network device 110. The first network device 110 may configure a TDM pattern to the terminal device 130 based on the suggested TDM pattern.

In this way, MUSIM gap collision may be solved by using a TDM pattern.

### Embodiment 4

In this embodiment, the second occasion is a periodic MUSIM gap occasion.

In some embodiments, if the second occasion collides with the first occasion (such as a SMTC occasion, a measurement gap occasion, a SSB occasion, a CSI-RS occasion, a the one of the first operation and the second operation based on a first priority of the first occasion and a second priority of the second occasion.

In some embodiments, if the first priority is higher than the second priority, i.e., the first occasion has a higher priority than the second occasion, the terminal device 130 may perform the first operation on the first occasion. In this case, the second occasion may be considered to be dropped.

In some embodiments, if the first priority is lower than the second priority, i.e., the second occasion has a higher priority than the first occasion, the terminal device 130 may perform the second operation on the second occasion. In this case, the first occasion may be considered to be dropped.

In some embodiments, the first network device 110 may transmit, to the terminal device 130, a fourth configuration indicating at least one of the first priority or the second priority. In some embodiments, the fourth configuration may be carried by a radio resource control (RRC) message, e.g., a RRC reconfiguration message. It is to be understood that any other suitable ways are also feasible.

In some embodiments, the first network device 110 may configure priorities for MUSIM gap and for a SMTC, a measurement gap, a SSB, a CSI-RS, a PRS, or another MUSIM gap. In some embodiments, the first network device 110 may configure a priority for a MUSIM gap, and a priority for a SMTC, a measurement gap, a SSB, a CSI-RS or a PRS may be set as a pre-defined value.

In some embodiments, the terminal device 130 may transmit, to the first network device 110, a suggested priority for the second occasion (i.e., MUSIM gap). For example, the terminal device 130 may provide a suggested priority of a MUSIM gap when sending the MUSIM gap preference to the first network device 110. The first network device 110 may configure a priority of the MUSIM gap based on the suggested priority.

In this way, MUSIM gap collision may be solved by using priorities of occasions.

### Embodiment 5

In this embodiment, the second occasion is a periodic MUSIM gap occasion.

In some embodiments, if the second occasion collides with the first occasion (such as a SMTC occasion, a measurement gap occasion, a SSB occasion, a CSI-RS occasion, a the one of the first operation and the second operation based on a third priority of the first operation and a fourth priority of the second operation.

In some embodiments, if the third priority is higher than the fourth priority, i.e., the first operation has a higher priority than the second operation, the terminal device 130 may perform the first operation on the first occasion. In this case, the second occasion may be considered to be dropped.

In some embodiments, if the third priority is lower than the fourth priority, i.e., the second operation has a higher priority than the first operation, the terminal device 130 may perform the second operation on the second occasion. In this case, the first occasion may be considered to be dropped.

In some embodiments, the first network device 110 may transmit, to the terminal device 130, a fifth configuration indicating at least one of the third priority or the fourth priority. In some embodiments, the fifth configuration may be carried by a RRC message, e.g., a RRC reconfiguration message. It is to be understood that any other suitable ways are also feasible.

In some embodiments, the first network device 110 may configure priorities for the second operation and for the first operation. In some embodiments, the first network device 110 may configure a priority for the second operation, and a priority for the first operation may be set as a pre-defined value.

In some embodiments, the terminal device 130 may transmit, to the first network device 110, a suggested priority for the second operation. For example, the terminal device 130 may provide a suggested priority of the second operation when sending the MUSIM gap preference to the first network device 110. The first network device 110 may configure a priority of the second operation based on the suggested priority.

In this way, MUSIM gap collision may be solved by using priorities of operations or behaviors.

### Embodiment 6

In this embodiment, the second occasion is a periodic MUSIM gap occasion.

In some embodiments, if the second occasion collides with the first occasion (such as a SMTC occasion, a measurement gap occasion, a SSB occasion, a CSI-RS occasion, a the one of the first operation and the second operation based on a first periodicity of the first occasion and a second periodicity of the second occasion.

In some embodiments, if the first periodicity is greater than the second periodicity, i.e., the first occasion has a longer periodicity than the second occasion, the terminal device 130 may perform the first operation on the first occasion. In this case, the second occasion may be considered to be dropped.

In some embodiments, if the first periodicity is smaller than the second periodicity, i.e., the second occasion has a longer periodicity than the first occasion, the terminal device 130 may perform the second operation on the second occasion. In this case, the first occasion may be considered to be dropped.

In this way, MUSIM gap collision may be solved by using periodicities of occasions.

### Embodiment 7

In this embodiment, the second occasion is a periodic MUSIM gap occasion.

In some embodiments, if the second occasion collides with the first occasion (such as a SMTC occasion, a measurement gap occasion, a SSB occasion, a CSI-RS occasion, a PRS occasion, or another MUSIM gap occasion), the terminal device 110 may perform the first operation with a relaxed minimum requirement (for convenience, also referred to as a first relaxed minimum requirement herein). In some embodiments, the relaxed minimum requirement may be a time period requirement. In this way, periodicity of the first occasion may be changed, and the MUSIM gap collision may be alleviated.

In some embodiments, the first network device 110 may transmit, to the terminal device 130, an indication of applying the first relaxed minimum requirement. In some embodiments, the terminal device 130 may follow the first relaxed minimum requirement without indication from the first network device 110.

In some embodiments, the terminal device 130 may determine the first relaxed minimum requirement based on a first factor (e.g., denoted as K1) and an original minimum requirement (for convenience, also referred to as a first original minimum requirement) for the first operation. In some embodiments, the terminal device 130 may determine the first relaxed minimum requirement by multiplying the first original minimum requirement with the first factor. In the context of the present disclosure, the first factor may also be referred to as a first relaxation factor or a first scaling factor.

In some embodiments, the first network device 110 may transmit a configuration of the first factor to the terminal device 130. That is, the first network device 110 may configure the first factor K1 to the terminal device 130. In some embodiments, the first network device 110 may configure the first factor K1 in system information. In some embodiments, the first network device 110 may configure the first factor K1 in a RRC message, e.g., a RRC Reconfiguration message or any other suitable messages.

In some embodiments, the terminal device 130 may transmit a suggested factor (for convenience, also referred to as a first suggested factor and denoted as K1′ herein) to the first network device 110. Based on the first suggested factor K1′, the first network device 110 may configure the first factor K1 to the terminal device 130.

In some embodiments, the terminal device 130 may determine the first factor K1. In some embodiments, the terminal device 130 may determine the first factor K1 based on a ratio of a first periodicity of the first occasion to a second periodicity of the second occasion. For example, the terminal device 130 may determine the first factor K1 based on equation (1) below.

$$K 1 = 1 / ( 1 ( P 1 / P 2 ) ) \qquad ( 1 )$$

where K1 denotes the first factor, P1 denotes the first periodicity of the first occasion, and P2 denotes the second periodicity of the second occasion. It is to be understood that the equation (1) is merely an example, and any other suitable forms are also feasible.

In some embodiments, the terminal device 130 may determine the first factor K1 based on the number of first occasions within a time window (for convenience, also referred to as a first time window herein) and the number of first occasions non-overlapped with the set of second occasions within the first time window. For example, the terminal device 130 may determine the first factor K1 based on equation (2) below.

$$K 1 = {N}_{total 1} / {N}_{available 1} \qquad ( 2 )$$

where K1 denotes the first factor, Nₜₒₜₐₗ₁ denotes the number of first occasions within the first time window, and N_{available1} denotes the number of first occasions non-overlapped with the set of second occasions within the first time window. It is to be understood that the equation (2) is merely an example, and any other suitable forms are also feasible.

In some embodiments, the first time window may be associated with a first periodicity of the first occasion or a maximum periodicity of MUSIM gaps. For example, the first time window may be determined by equation (3) below.

$$T 1 = max \{ P 1 , {P}_{max 1} \} \qquad ( 3 )$$

where T1 denotes the first time window, P1 denotes the first periodicity of the first occasion, and Pₘₐₓ₁ denotes the maximum periodicity of MUSIM gaps. It is to be understood that the equation (3) is merely an example, and any other suitable ways are also feasible for determination of the first time window.

In some embodiments, the terminal device 130 may determine the first factor K1 based on the number of first occasions within a time window (for convenience, also referred to as a second time window herein) and the number of first occasions non-overlapped with the set of second occasions or a measurement gap within the second time window. For example, the terminal device 130 may determine the first factor K1 based on equation (4) below.

$$K 1 = {N}_{total 2} / {N}_{available 2} \qquad ( 4 )$$

where K1 denotes the first factor, Nₜₒₜₐₗ₂ denotes the number of first occasions within the second time window, and N_{available2} denotes the number of first occasions non-overlapped with the set of second occasions or a measurement gap within the second time window. It is to be understood that the equation (4) is merely an example, and any other suitable forms are also feasible.

In some embodiments, the second time window may be associated with a first periodicity of the first occasion, a maximum periodicity of MUSIM gaps or a maximum periodicity of measurement gaps. For example, the second time window may be determined by equation (5) below.

$$T 2 = max \{ P 1 , {P}_{max 1} , {P}_{max 2} \} \qquad ( 5 )$$

where T2 denotes the second time window, P1 denotes the first periodicity of the first occasion, Pₘₐₓ₁ denotes the maximum periodicity of MUSIM gaps, and Pₘₐₓ₂ denotes the maximum periodicity of measurement gaps. It is to be understood that the equation (5) is merely an example, and any other suitable ways are also feasible for determination of the second time window.

In some embodiments, the terminal device 130 may determine the first factor based on a second factor (e.g., relaxation factor or scaling factor) for the second operation. In the context of the present disclosure, the second factor may also be referred to as a second relaxation factor or a second scaling factor. For example, the terminal device 130 may determine the first factor by equation (6) below.

$$K 1 = 1 / ( 1 - 1 / K 2 ) \qquad ( 6 )$$

where K1 denotes the first factor, and K2 denotes the second factor. It is to be understood that the equation (6) is merely an example, and any other suitable forms are also feasible.

In this way, MUSIM gap collision may be alleviated by applying a relaxed minimum requirement for the first operation.

### Embodiment 8

In this embodiment, the second occasion is a periodic MUSIM gap occasion.

In some embodiments, if the second occasion collides with the first occasion (such as a SMTC occasion, a measurement gap occasion, a SSB occasion, a CSI-RS occasion, a PRS occasion, or another MUSIM gap occasion), the terminal device 110 may perform the second operation with a relaxed minimum requirement (for convenience, also referred to as a second relaxed minimum requirement herein). In some embodiments, the relaxed minimum requirement may be a time period requirement. In this way, periodicity of the second occasion may be changed, and the MUSIM gap collision may also be alleviated.

In some embodiments, the second network device 120 may transmit, to the terminal device 130, an indication of applying the second relaxed minimum requirement. In some embodiments, the terminal device 130 may follow the second relaxed minimum requirement without indication from the second network device 120.

In some embodiments, the terminal device 130 may determine the second relaxed minimum requirement based on the second factor mentioned above (denoted as K2) and an original minimum requirement (for convenience, also referred to as a second original minimum requirement) for the second operation. In some embodiments, the terminal device 130 may determine the second relaxed minimum requirement by multiplying the second original minimum requirement with the second factor.

In some embodiments, the second network device 120 may transmit a configuration of the second factor to the terminal device 130. That is, the second network device 120 may configure the second factor K2 to the terminal device 130. In some embodiments, the second network device 120 may configure the second factor K2 in system information. In some embodiments, the second network device 120 may configure the second factor K2 in a RRC message, e.g., a RRC release message or any other suitable messages.

In some embodiments, the terminal device 130 may transmit a suggested factor (for convenience, also referred to as a second suggested factor and denoted as K2′ herein) to the second network device 120. Based on the second suggested factor K2′, the second network device 120 may configure the second factor K2 to the terminal device 130.

In some embodiments, the terminal device 130 may determine the second factor K2. In some embodiments, the terminal device 130 may determine the second factor K2 based on a ratio of a second periodicity of the second occasion to a first periodicity of the first occasion. For example, the terminal device 130 may determine the second factor K2 based on equation (7) below.

$$K 2 = 1 / ( 1 - ( P 2 / P 1 ) ) \qquad ( 7 )$$

where K2 denotes the second factor, P1 denotes the first periodicity of the first occasion, and P2 denotes the second periodicity of the second occasion. It is to be understood that the equation (7) is merely an example, and any other suitable forms are also feasible.

In some embodiments, the terminal device 130 may determine the second factor K2 based on the number of second occasions within a time window (for convenience, also referred to as a third time window herein) and the number of second occasions non-overlapped with the set of first occasions within the third time window. For example, the terminal device 130 may determine the second factor K2 based on equation (8) below.

$$K 2 = {N}_{total 33} / {N}_{available 3} \qquad ( 8 )$$

where K2 denotes the second factor, Nₜₒₜₐₗ₃ denotes the number of second occasions within the third time window, and N_{available3} denotes the number of first occasions non-overlapped with the set of first occasions within the third time window. It is to be understood that the equation (8) is merely an example, and any other suitable forms are also feasible.

In some embodiments, the third time window may be associated with a second periodicity of the second occasion or a maximum periodicity of the first occasions or a maximum periodicity of MUSIM gaps. For example, the third time window may be determined by equation (9) below.

$$T 3 = max \{ P 2 , {P}_{max 2} \} or {P}_{max 1} \} \qquad ( 9 )$$

where T3 denotes the third time window, P2 denotes the second periodicity of the second occasion, Pₘₐₓ₁ denotes the maximum periodicity of MUSIM gaps, and Pₘₐₓ₂ denotes the maximum periodicity of the first occasions. It is to be understood that the equation (9) is merely an example, and any other suitable ways are also feasible for determination of the third time window.

In some embodiments, the terminal device 130 may determine the second factor based on the first factor for the first operation. For example, the terminal device 130 may determine the second factor by equation (10) below.

$$K 2 = 1 / ( 1 - 1 / K 1 ) \qquad ( 10 )$$

where K1 denotes the first factor, and K2 denotes the second factor. It is to be understood that the equation (10) is merely an example, and any other suitable forms are also feasible.

In this way, MUSIM gap collision may be alleviated by applying a relaxed minimum requirement for the second operation.

It is to be understood that solutions as described in Embodiments 1 to 8 may be used separately or in any suitable combination.

### Example Implementation of Methods

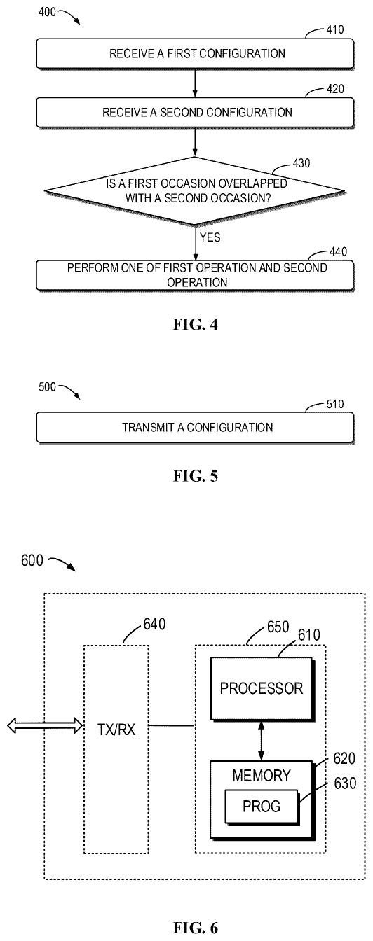

Accordingly, embodiments of the present disclosure provide methods of communication implemented at a terminal device and a network device. These methods will be described below with reference to FIGS. 4 to 5.

FIG. 4 illustrates an example method 400 of communication implemented at a terminal device in accordance with some embodiments of the present disclosure. For example, the method 400 may be performed at the terminal device 130 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

In this example, the first network device 110 is associated with a first subscriber identity module of the terminal device 130 and the second network device 120 is associated with a second subscriber identity module of the terminal device 130. The terminal device 130 is in a connected state for the first network device 110 and is in an idle or inactive state for the second network device 120.

At block 410, the terminal device 130 receives, from the first network device 110, a first configuration indicating a set of first occasions, the set of first occasions being associated with a first operation for the first network device 110 or the second network device 120.

At block 420, the terminal device 130 receives, from the first network device 110, a second configuration indicating a set of second occasions, the set of second occasions being associated with a second operation for the second network device 120 in a MUSIM gap.

At block 430, the terminal device 130 determines whether a first occasion in the set of first occasions is overlapped with a second occasion in the set of second occasions. If the first occasion is overlapped (e.g., fully or partially overlapped) with the second occasion, the process 400 may proceed to block 440.

At block 440, the terminal device 130 performs one of the first operation and the second operation at least based on periodicity of the MUSIM gap.

In some embodiments, the first occasion may comprise: an occasion for a measurement gap; an occasion for a SMTC; an occasion for a CSI-RS; an occasion for a PRS; an occasion for a SSB; or an occasion for a further MUSIM gap.

In some embodiments, the first operation may comprise signal measurement, radio link failure monitoring, beam failure monitoring, intra-frequency measurement, inter-frequency measurement or positioning measurement. In some embodiments, the second operation may comprise measurement for cell reselection or paging reception.

In some embodiments where the MUSIM gap is aperiodic, the terminal device 130 may perform the one of the first operation and the second operation by at least one of the following: dropping the first occasion; or performing the second operation on the second occasion.

In some embodiments where the MUSIM gap is periodic, the terminal device 130 may perform the one of the first operation and the second operation by at least one of the following: dropping the first occasion; or performing the second operation on the second occasion.

In some embodiments where the MUSIM gap is periodic, the terminal device 130 may perform the one of the first operation and the second operation by at least one of the following: dropping the second occasion; or performing the first operation on the first occasion.

In some embodiments where the MUSIM gap is periodic, the terminal device 130 may perform the one of the first operation and the second operation by determining the one of the first operation and the second operation based on a TDM pattern.

In some embodiments, the TDM pattern is pre-defined.

In some embodiments, the terminal device 130 may receive, from the first network device 110, a third configuration indicating the TDM pattern. In some embodiments, the terminal device 130 may transmit a suggested TDM pattern to the first network device 110. In some embodiments, the terminal device 130 may transmit a suggested TDM pattern to the first network device 110 and receive, from the first network device 110, a third configuration indicating the TDM pattern.

In some embodiments where the MUSIM gap is periodic, the terminal device 130 may perform the one of the first operation and the second operation by determining the one of the first operation and the second operation based on a first priority of the first occasion and a second priority of the second occasion.

In some embodiments, the terminal device 130 may receive, from the first network device 110, a fourth configuration indicating at least one of the first priority or the second priority. In some embodiments, the terminal device 130 may transmit, to the first network device 110, a suggested priority for the second occasion. In some embodiments, the terminal device 130 may transmit, to the first network device 110, a suggested priority for the second occasion and receive, from the first network device 110, a fourth configuration indicating at least one of the first priority or the second priority.

In some embodiments where the MUSIM gap is periodic, the terminal device 130 may perform the one of the first operation and the second operation by determining the one of the first operation and the second operation based on a third priority of the first operation and a fourth priority of the second operation.

In some embodiments, the terminal device 130 may receive, from the first network device 110, a fifth configuration indicating at least one of the third priority or the fourth priority. In some embodiments, the terminal device 130 may transmit, to the first network device 110, a suggested priority for the second operation. In some embodiments, the terminal device 130 may transmit, to the first network device 110, a suggested priority for the second operation, and receive, from the first network device 110, a fifth configuration indicating at least one of the third priority or the fourth priority.

In some embodiments where the MUSIM gap is periodic, the terminal device 130 may perform the one of the first operation and the second operation by determining the one of the first operation and the second operation based on a first periodicity of the first occasion and a second periodicity of the second occasion.

In some embodiments where the MUSIM gap is periodic, the terminal device 130 may perform the one of the first operation and the second operation by performing the first operation with a first relaxed minimum requirement.

In some embodiments, the terminal device 130 may receive, from the first network device 110, an indication of applying the first relaxed minimum requirement.

In some embodiments, the terminal device 130 may determine the first relaxed minimum requirement based on a first factor and a first original minimum requirement.

In some embodiments, the terminal device 130 may receive, from the first network device 110, a configuration of the first factor. In some embodiments, the terminal device 130 may transmit a first suggested factor to the first network device 110. In some embodiments, the terminal device 130 may determine the first factor based on a ratio of a first periodicity of the first occasion to a second periodicity of the second occasion. In some embodiments, the terminal device 130 may determine the first factor based on the number of first occasions within a first time window and the number of first occasions non-overlapped with the set of second occasions within the first time window, the first time window being associated with a first periodicity of the first occasion or a maximum periodicity of MUSIM gaps. In some embodiments, the terminal device 130 may determine the first factor based on the number of first occasions within a second time window and the number of first occasions non-overlapped with the set of second occasions or a measurement gap within the second time window, the second time window being associated with a first periodicity of the first occasion, a maximum periodicity of MUSIM gaps or a maximum periodicity of measurement gaps. In some embodiments, the terminal device 130 may determine the first factor based on a second factor for the second operation. It is to be understood that any combination of the above embodiments may also be feasible. In some embodiments where the MUSIM gap is periodic, the terminal device 130 may perform the one of the first operation and the second operation by performing the second operation with a second relaxed minimum requirement.

In some embodiments, the terminal device 130 may receive, from the second network device 120, an indication of applying the second relaxed minimum requirement.

In some embodiments, the terminal device 130 may determine the second relaxed minimum requirement based on a second factor and a second original minimum requirement.

In some embodiments, the terminal device 130 may receive, from the second network device 120, a configuration of the second factor. In some embodiments, the terminal device 130 may transmit a second suggested factor to the second network device 120. In some embodiments, the terminal device 130 may determine the second factor based on a ratio of a second periodicity of the second occasion to a first periodicity of the first occasion. In some embodiments, the terminal device 130 may determine the second factor based on the number of second occasions within a third time window and the number of second occasions non-overlapped with the set of first occasions within the third time window, the third time window being associated with a second periodicity of the second occasion or a maximum periodicity of the first occasions or a maximum periodicity of MUSIM gaps. In some embodiments, the terminal device 130 may determine the second factor based on a first factor for the first operation. It is to be understood that any combination of the above embodiments may also be feasible.

FIG. 5 illustrates an example method 500 of communication implemented at a first network device in accordance with some embodiments of the present disclosure. For example, the method 500 may be performed at the first network device 110 or the second network device 120 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

As shown in FIG. 5, at block 510, the first network device 110 transmits, to the terminal device 130, at least one of the following: a third configuration indicating a TDM pattern, the TDM pattern indicating whether a first operation for the first network device 110 or the second network device 120 or a second operation for the second network device 120 is performed; a fourth configuration indicating at least one of a first priority of a first occasion for the first operation or a second priority of a second occasion for the second operation; a fifth configuration indicating at least one of a third priority of the first operation or a fourth priority of the second operation; an indication of applying a first relaxed minimum requirement for the first operation; an indication of applying a second relaxed minimum requirement for the second operation; or a configuration of a first factor for the first operation.

In some embodiments, the first network device 110 may receive, from the terminal device 130, at least one of the following: a suggested TDM pattern; a suggested priority for the second occasion; a suggested priority for the second operation; or a first suggested factor for the first operation.

It is to be understood that the operations of methods 400 and 500 are similar as that described in connection with FIG. 3, and thus other details are not repeated here for concise.

### Example Implementation of Devices and Apparatuses

FIG. 6 is a simplified block diagram of a device 600 that is suitable for implementing embodiments of the present disclosure. The device 600 can be considered as a further example implementation of the terminal device 130 or the first network device 110 or the second network device 120 as shown in FIG. 1. Accordingly, the device 600 can be implemented at or as at least a part of the terminal device 130 or the first network device 110 or the second network device 120.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

In some embodiments, a terminal device comprises a circuitry configured to: receive, at a terminal device and from a first network device, a first configuration indicating a set of first occasions, the set of first occasions being associated with a first operation for the first network device or a second network device; receive, from the first network device, a second configuration indicating a set of second occasions, the set of second occasions being associated with a second operation for the second network device in a MUSIM gap; and in accordance with a determination that a first occasion in the set of first occasions is overlapped with a second occasion in the set of second occasions, perform one of the first operation and the second operation at least based on periodicity of the MUSIM gap.

In some embodiments, a first network device comprises a circuitry configured to: transmit, at a first network device and to a terminal device, at least one of the following: a third configuration indicating a TDM pattern, the TDM pattern indicating whether a first operation for the first network device or a second network device or a second operation for the second network device is performed; a fourth configuration indicating at least one of a first priority of a first occasion for the first operation or a second priority of a second occasion for the second operation; a fifth configuration indicating at least one of a third priority of the first operation or a fourth priority of the second operation; an indication of applying a first relaxed minimum requirement for the first operation; an indication of applying a second relaxed minimum requirement for the second operation; or a configuration of a first factor for the first operation.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receiving, at a terminal device and from a first network device, a first configuration indicating a set of first occasions, the set of first occasions being associated with a first operation for the first network device or a second network device; receiving, from the first network device, a second configuration indicating a set of second occasions, the set of second occasions being associated with a second operation for the second network device in a multi-universal subscriber identity module (MUSIM) gap; and in accordance with a determination that a first occasion in the set of first occasions is overlapped with a second occasion in the set of second occasions, performing one of the first operation and the second operation at least based on periodicity of the MUSIM gap.

In some embodiments, the first network device is associated with a first subscriber identity module of the terminal device and the second network device is associated with a second subscriber identity module of the terminal device, and the terminal device is in a connected state for the first network device and is in an idle or inactive state for the second network device.

In some embodiments, the first occasion comprises: an occasion for a measurement gap; an occasion for a synchronization signal and physical broadcast channel block (SSB)-based RRM measurement timing configuration (SMTC); an occasion for a channel state information-reference signal (CSI-RS); an occasion for a positioning reference signal (PRS); an occasion for a SSB; or an occasion for a further MUSIM gap.

In some embodiments, the first operation comprises signal measurement, radio link failure monitoring, beam failure monitoring, intra-frequency measurement, inter-frequency measurement or positioning measurement, and the second operation comprises measurement for cell reselection or paging reception.

In some embodiments, the MUSIM gap is aperiodic, and performing the one of the first operation and the second operation comprises at least one of the following: dropping the first occasion; or performing the second operation on the second occasion.

In some embodiments, the MUSIM gap is periodic, and performing the one of the first operation and the second operation comprises at least one of the following: dropping the first occasion; or performing the second operation on the second occasion.

In some embodiments, the MUSIM gap is periodic, and performing the one of the first operation and the second operation comprises at least one of the following: dropping the second occasion; or performing the first operation on the first occasion.

In some embodiments, the MUSIM gap is periodic, and performing the one of the first operation and the second operation comprises: determining the one of the first operation and the second operation based on a time domain multiplexing (TDM) pattern.

In some embodiments, the TDM pattern is pre-defined.

In some embodiments, the method above further comprises at least one of the following: receiving, from the first network device, a third configuration indicating the TDM pattern; or transmitting a suggested TDM pattern to the first network device.

In some embodiments, the MUSIM gap is periodic, and performing the one of the first operation and the second operation comprises: determining the one of the first operation and the second operation based on a first priority of the first occasion and a second priority of the second occasion.

In some embodiments, the method above further comprises at least one of: receiving, from the first network device, a fourth configuration indicating at least one of the first priority or the second priority; or transmitting, to the first network device, a suggested priority for the second occasion.

In some embodiments, the MUSIM gap is periodic, and performing the one of the first operation and the second operation comprises: determining the one of the first operation and the second operation based on a third priority of the first operation and a fourth priority of the second operation.

In some embodiments, the method above further comprises at least one of: receiving, from the first network device, a fifth configuration indicating at least one of the third priority or the fourth priority; or transmitting, to the first network device, a suggested priority for the second operation.

In some embodiments, the MUSIM gap is periodic, and performing the one of the first operation and the second operation comprises: determining the one of the first operation and the second operation based on a first periodicity of the first occasion and a second periodicity of the second occasion.

In some embodiments, the MUSIM gap is periodic, and performing the one of the first operation and the second operation comprises: performing the first operation with a first relaxed minimum requirement.

In some embodiments, the method above further comprises: receiving, from the first network device, an indication of applying the first relaxed minimum requirement.

In some embodiments, the method above further comprises: determining the first relaxed minimum requirement based on a first factor and a first original minimum requirement.

In some embodiments, the method above further comprises at least one of the following: receiving, from the first network device, a configuration of the first factor; transmitting a first suggested factor to the first network device; determining the first factor based on a ratio of a first periodicity of the first occasion to a second periodicity of the second occasion; determining the first factor based on the number of first occasions within a first time window and the number of first occasions non-overlapped with the set of second occasions within the first time window, the first time window being associated with a first periodicity of the first occasion or a maximum periodicity of MUSIM gaps; determining the first factor based on the number of first occasions within a second time window and the number of first occasions non-overlapped with the set of second occasions or a measurement gap within the second time window, the second time window being associated with a first periodicity of the first occasion, a maximum periodicity of MUSIM gaps or a maximum periodicity of measurement gaps; or determining the first factor based on a second factor for the second operation.

In some embodiments, the MUSIM gap is periodic, and performing the one of the first operation and the second operation comprises: performing the second operation with a second relaxed minimum requirement.

In some embodiments, the method above further comprises: receiving, from the second network device, an indication of applying the second relaxed minimum requirement.

In some embodiments, the method above further comprises: determining the second relaxed minimum requirement based on a second factor and a second original minimum requirement.

In some embodiments, the method above further comprises at least one of the following: receiving, from the second network device, a configuration of the second factor; transmitting a second suggested factor to the second network device; determining the second factor based on a ratio of a second periodicity of the second occasion to a first periodicity of the first occasion; determining the second factor based on the number of second occasions within a third time window and the number of second occasions non-overlapped with the set of first occasions within the third time window, the third time window being associated with a second periodicity of the second occasion or a maximum periodicity of the first occasions or a maximum periodicity of MUSIM gaps; or determining the second factor based on a first factor for the first operation.

In another solution, a method of communication comprises: transmitting, at a first network device and to a terminal device, at least one of the following: a third configuration indicating a time domain multiplexing (TDM) pattern, the TDM pattern indicating whether a first operation for the first network device or a second network device or a second operation for the second network device is performed; a fourth configuration indicating at least one of a first priority of a first occasion for the first operation or a second priority of a second occasion for the second operation; a fifth configuration indicating at least one of a third priority of the first operation or a fourth priority of the second operation; an indication of applying a first relaxed minimum requirement for the first operation; an indication of applying a second relaxed minimum requirement for the second operation; or a configuration of a first factor for the first operation.

In some embodiments, the method above further comprises: receiving, from the terminal device, at least one of the following: a suggested TDM pattern; a suggested priority for the second occasion; a suggested priority for the second operation; or a first suggested factor for the first operation.

In another solution, a device of communication comprises a processor configured to cause the device to perform the method according to any of the claims above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method for a terminal device, the method comprising:
performing an operation related to a Multi-Universal Subscriber Identity Module (MUSIM) gap; and
in a case where a periodic MUSIM gap occasion collides with an aperiodic MUSIM gap occasion, dropping the periodic MUSIM gap occasion.

22. The method according to claim 21, the method further comprising:
in a case where a measurement gap occasion collides with the aperiodic MUSIM gap occasion, dropping the measurement gap occasion.

23. A method for a terminal device, the method comprising:
performing an operation related to a Multi-Universal Subscriber Identity Module (MUSIM) gap; and
in a case where a measurement gap occasion collides with an aperiodic MUSIM gap occasion, dropping the measurement gap occasion.

24. The method according to claim 23, the method further comprising:
in a case where a periodic MUSIM gap occasion collides with the aperiodic MUSIM gap occasion, dropping the periodic MUSIM gap occasion.

25. A terminal device comprising:
at least one memory; and
at least one processor coupled to the at least one memory and configured to:
perform an operation related to a Multi-Universal Subscriber Identity Module (MUSIM) gap; and
in a case where a periodic MUSIM gap occasion collides with an aperiodic MUSIM gap occasion, drop the periodic MUSIM gap occasion.

26. The terminal device according to claim 25,
wherein the processor is further configured to:
in a case where a measurement gap occasion collides with the aperiodic MUSIM gap occasion, drop the measurement gap occasion.
